(19) United States
(12) Patent Application Publication
(10) Pub. No.: US 2006/0208855 A1
(43) Pub. Date: Sep. 21, 2006

(54) In-vehicle receiver having interior and exterior antennas

(75) Inventor: Noriaki Okada, Chiryu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/352,359

(22) Filed: Feb. 13, 2006

(30) Foreign Application Priority Data
Mar. 4, 2005 (JP) 2005-60388

(51) Int. Cl. B60R 25/00; G05B 19/00; H04B 5/00; H04B 7/00

(52) U.S. Cl. 340/5.72; 340/5.64; 455/41.1; 455/41.2

(57) ABSTRACT

A receiver to be used in a smart entry system for a vehicle is provided with an antenna device for receiving a transmission radio wave from a portable device, a receiver circuit for demodulating a receiving signal inputted from the antenna device to extract receiving data, and an AV wire mounted in a rear bumper of the vehicle. The antenna device is constructed with a built-in antenna built in the receiver for receiving a radio wave, an impedance matching circuit for performing impedance matching with the built-in antenna, and a Wilkinson combining circuit which receives input of a first receiving signal received by the built-in antenna and a second receiving signal received by the AV wire to output a signal produced by combining the inputs of the first receiving signal and second receiving signal.

### CROSS REFERENCE TO RELATED APPLICATION

This application is based on and incorporates herein by reference Japanese Patent Application No. 2005-60388 filed on Mar. 4, 2005.

### FIELD OF THE INVENTION

The present invention relates to an in-vehicle receiver and, in particular, to a receiver for a smart entry system of vehicles.

### BACKGROUND OF THE INVENTION

A smart entry system is known as exemplified in, for example, JP-A-2000-104429 or JP-A-2003-157483. In this system, a transmission request signal is transmitted from an in-vehicle transmitter to a prescribed range, and an in-vehicle receiver receives a response signal from a portable device which has received the transmission request signal. A control device in a vehicle compares an ID code as identification information included in the response signal received by the in-vehicle receiver with an ID code registered inside the control device. When both ID codes correspond with each other, it is assumed that the authentication is established, and thereby door is unlocked by driving an actuator or manual door unlock is permitted, or a vehicle control such as engine starting is permitted.

A vehicle is, however, made of metal and therefore a radio wave environment in the surrounding area of an in-vehicle receiver mounted inside a vehicle largely varies depending on a difference of a mount position of the in-vehicle receiver. In addition, there possibly exists a region where it is difficult to receive a response signal at a sufficient receiving level within the neighboring region of the in-vehicle receiver intended so as to receive the response signal from a portable device, depending on receiving performance or a mount position of the in-vehicle receiver. This region is referred to as a radio wave dead zone of the in-vehicle receiver.

Accordingly, in addition to an antenna (interior built-in antenna) built in the in-vehicle receiver, an antenna (exterior antenna) for receiving the response signal from the radio wave dead zone of the in-vehicle receiver at a sufficient receiving level is conventionally mounted on the vehicle. That is, as shown in FIG. 7, a built-in antenna 101 is connected directly to an exterior antenna 103, so that a signal to be produced by combining a receiving signal (built-in antenna receiving signal) received by the built-in antenna 101 with a receiving signal (exterior antenna receiving signal) received by the exterior antenna 103 is to be inputted to an in-vehicle receiver 105.

However, when the built-in antenna 101 is thus connected directly to the exterior antenna 103, the built-in antenna receiving signal and the exterior antenna receiving signal interfere with each other at each of both a built-in antenna input terminal 111 and an exterior antenna input terminal 113. As a result, the built-in antenna receiving signal received by the built-in antenna 101 is not sufficiently transmitted to the built-in antenna input terminal 111 and also the exterior antenna receiving signal received by the exterior antenna 103 is not sufficiently transmitted to the exterior antenna input terminal 113.

Therefore, regardless of the mounting of the exterior antenna, there still exists a region where the radio wave dead zone of the in-vehicle receiver cannot be eliminated.

Further, it is also well known to use, like the diversity, two antennas so that one of the antennas receiving a stronger radio wave is selected to receive that signal. When the diversity is, however, adopted, the strength of the radio wave must be monitored, thus requiring complicated system construction.

### SUMMARY OF THE INVENTION

The present invention therefore has an object to provide an in-vehicle receiver for a vehicle capable of eliminating with a simple construction a region where it is difficult for an in-vehicle receiver to receive a signal at a sufficient level.

In a receiver for a vehicle according to an aspect of the present invention, a first antenna receives a portable device wireless signal transmitted from a portable device, and a second antenna receives the portable device wireless signal transmitted from a region where it is difficult to receive the portable device wireless signal by means of the first antenna, within a neighboring region of a vehicle in which the receiver is mounted. A Wilkinson combining circuit receives input of a first receiving signal as the portable device wireless signal received by the first antenna and a second receiving signal as the portable device wireless signal received by the second antenna. The circuit outputs a signal produced by combining the inputs of the first receiving signal and second receiving signal.

The Wilkinson combining circuit is a circuit which isolates and combines signals inputted from two input terminals. The isolation is made possible between the first input terminal for inputting the first receiving signal from the first antenna and the second input terminal for inputting the second receiving signal from the second antenna by means of the Wilkinson combining circuit. Therefore, the first receiving signal and the second receiving signal do not interfere with each other in each of the first input terminal and the second input terminal. Accordingly, the region where it is difficult to receive the portable device wireless signal due to interference between the first receiving signal and the second receiving signal is eliminated.

An AV wire (low-voltage electric wire) mounted in a vehicle in which the receiver is mounted may be used as the second antenna. The AV wire is advantageous in that it is very inexpensive as compared to an antenna used in general for receiving a radio wave.

### BRIEF DESCRIPTION OF THE DRAWINGS

These and other objects, features, aspects and advantages of the present invention will become more apparent to those skilled in the art from the following detailed description, which, taken in conjunction with the annexed drawings, discloses a preferred embodiment of the present invention. In the drawings:

FIG. 1 is a block diagram showing a smart entry system for a vehicle according to a preferred embodiment of the present invention;

FIG. 2 is a block diagram showing an in-vehicle receiver according to the preferred embodiment of the present invention;

FIG. 3 is a plan view showing a rear side of a vehicle for illustrating an arrangement of the receiver and an AV wire according to the preferred embodiment of the present invention;

FIG. 4 is a graph showing receiving characteristics in the surrounding area of a rear bumper in the receiver according to the preferred embodiment of the present invention and the conventional receiver;

FIG. 5 is a block diagram showing the conventional receiver;

FIG. 6 is a plan view showing a rear side of a vehicle for illustrating an inoperative area in the conventional receiver; and

FIG. 7 is a block diagram showing a construction of the conventional receiver.

### DETAILED DESCRIPTION OF THE PREFERRED EMBODIMENT

The following description of a preferred embodiment of the present invention is merely exemplary in nature and is in no way intended to limit the present invention, its application, or uses.

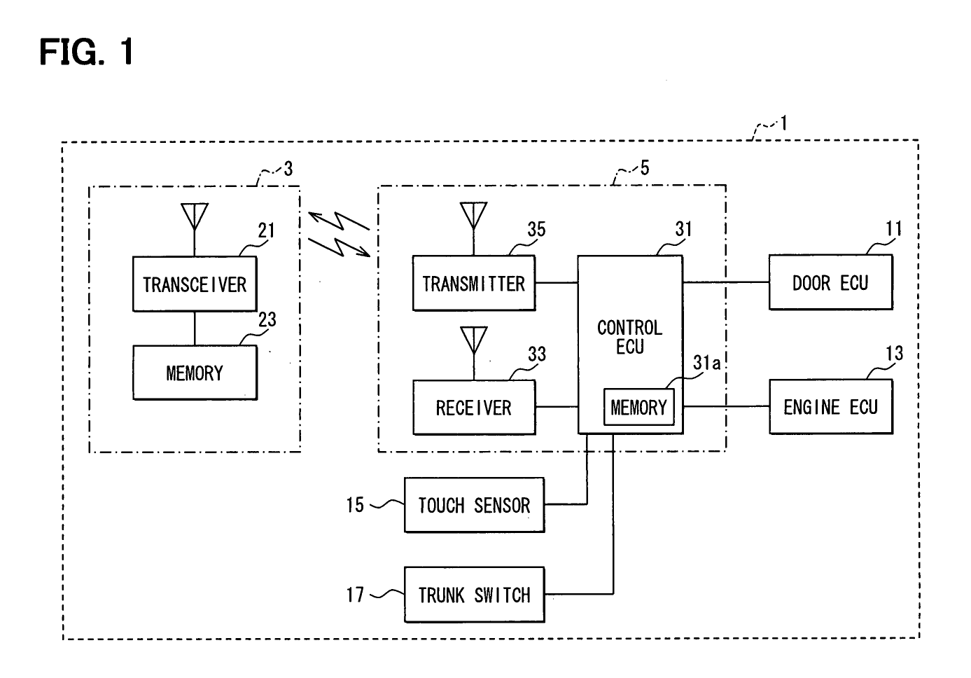

As shown in FIG. 1, a smart entry system 1 includes a portable device (electronic key) 3 to be carried by a user of a vehicle, an in-vehicle device 5 mounted in the vehicle, which carries out authentication by using identification information to be obtained through communication with the portable device 3 and outputs a command for performing a predetermined vehicle control when the authentication is established, a door ECU 11 for performing an opening/closing control of each door for the vehicle based upon a command from the in-vehicle device 5, an engine ECU 13 for performing an engine control based upon a command from the in-vehicle device 5, a touch sensor 15 built in a door handle of each passenger door (not shown) for getting on and off, which detects contact of a person with the door handle to output a detection signal to a control ECU 31 (described later) inside the in-vehicle device 5, and a trunk switch 17 disposed outside of a trunk door (not shown) for opening/closing a trunk, which, when the trunk switch 17 is activated for opening the truck door, outputs an operational signal for door opening to the control ECU 31. The portable device 3 is provided with a transponder 21 for transmitting/receiving data to or from the in-vehicle device 5, and a memory (nonvolatile memory) 23 for storing an ID code as identification information provided to each portable device 3.

In the portable device 3, when the transponder 21 receives a transmission request signal from the in-vehicle device 5, the transponder 21 transmits a response signal including an ID code stored in the memory 23.

The door ECU 11 is disposed in each of passenger doors and a trunk door for the vehicle and receives an unlock standby command for permitting unlock of a door from the in-vehicle device 5, thereby making each passenger door be in an unlock standby state. Thereafter, in the event of detecting the contact of a person by means of the touch sensor 15, the door ECU 11 performs the door unlock control to unlock each passenger door, as well as performing a control for opening the trunk door when receiving a trunk door opening command indicating opening of the trunk door from the in-vehicle device 5.

The in-vehicle device 5 includes a receiver 33 with antenna to receive a response signal from the portable device 3, a transmitter 35 with antenna to transmit a transmission request signal to the portable device 3, and a control ECU 31 which performs data communications with the door ECU 11 and the engine ECU 13 and also controls operations of the receiver 33 and the transmitter 35.

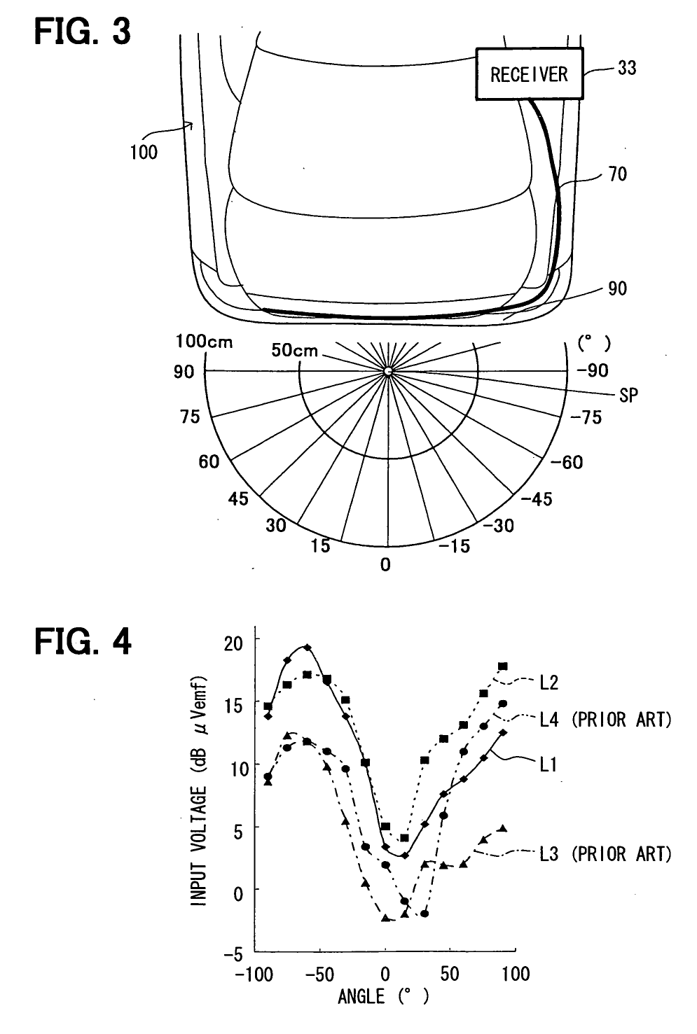

The receiver 33 may be arranged in the vicinity of a rear seat in a vehicle 100 as shown in FIG. 3 and receives a response signal (signal of hundreds of MHz frequency band) to be transmitted in response to the transmission request signal from the portable device 3 within a portable device responsive area, as well as decoding the ID code included in the response signal to output the decoded signal to the control ECU 31.

In addition, the transmitter 35 is disposed in each of the passenger doors and the trunk for the vehicle and transmits a transmission request signal (signal of hundreds and several tens kHz frequency band) to a wireless communication area in the surrounding area outside each passenger door and the trunk in response to a command from the control ECU 31.

In addition, the control ECU 31 is provided with a memory 31a for storing various data and the ID code allotted to the portable device 3 for the vehicle is stored in the memory 31a.

In the in-vehicle device 5, the control ECU 31 causes the transmitter 35 to transmit a transmission request signal on a periodic basis. When an ID code is inputted to the control ECU 31 from the receiver 33, i.e., when the receiver 33 receives the response signal, the control ECU 31 performs authentication. When the authentication of the portable device 3 is established, the control ECU 31 outputs an unlock standby command to the door ECU 11. In addition, when an ID code is inputted to the control ECU 31 from the trunk switch 17, the control ECU 31 causes the transmitter 35 to transmit the transmission request signal. When the ID code is, thereafter, inputted from the receiver 33, the control ECU 31 performs authentication. When the authentication is established, the control ECU 31 outputs a trunk door opening command to the door ECU 11.

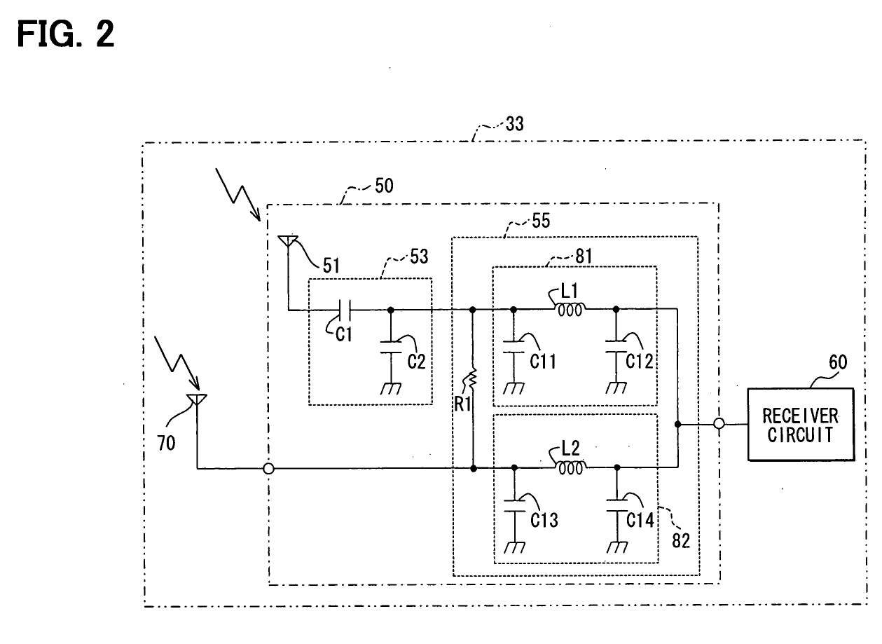

The receiver 33 is, as shown in FIG. 2, provided with an antenna device 50 for receiving a transmission radio wave from the portable device 3, a receiver circuit 60 for demodulating a receiving signal inputted from the antenna device 50 to extract receiving data, and an AV wire (low-voltage audio-visual electric wire) 70 mounted in the rear bumper 90 of the vehicle 100 as shown in FIG. 3.

The antenna 50 is provided with a built-in antenna 51 built in the receiver 33 for receiving a radio wave, an impedance matching circuit 53 for performing impedance matching (matched to 50 Ω) with the built-in antenna 51, and a known Wilkinson combining circuit 55 which receives input of a second receiving signal received by the AV wire 70 for establishing isolation between the built-in antenna 51 and the AV wire 70, while outputting a combined signal produced by combining the inputs of the first receiving signal and second receiving signal. Since this device is used in a frequency band of 300 MHz, a micro-strip line portion of λ/4 used usually in the Wilkinson circuit is replaced by a low pass filter.

The impedance matching circuit 53 is a known matching circuit formed of two capacitors C1 and C2. That is, the capacitor C1 has one end connected to the built-in antenna 51 and the other end connected to the Wilkinson combining circuit 55, and the capacitor C2 has one end connected to the Wilkinson combining circuit 55 and the other end earthed to the ground. Capacitances of the capacitors C1 and C2 each are 3 pF and 22 pF.

The Wilkinson combining circuit 55 is provided with a first transmission line path 81 which has one end connected to the impedance matching circuit 53 and the other end connected to the receiver circuit 60, a second transmission line path 83 which has one end connected to the AV wire 70 and the other end connected to the receiver circuit 60, and an absorption resistor R1 which has one end connected to the impedance matching circuit 53 and the other end connected to the AV wire 70. Each impedance of the first transmission line path 81 and the second transmission line path 83 is set to 70.7 Ωand a resistance value of the absorption resistor R1 is set to 100 Ω.

The first transmission line path 81 is formed of a coil L1 and two capacitors C11 and C12. That is, the coil L1 has one end connected to the impedance matching circuit 53 and the other end connected to the receiver circuit 60, the capacitor C11 has one end connected to the impedance matching circuit 53 and the other end earthed to the ground, and the capacitor C12 has one end connected to the receiver circuit 60 and the other end earthed to the ground. Each capacitance value of the capacitors C11 and C12 is 7 pF and an inductance value of the coil L1 is 39 nH.

The second transmission line path 83, in the same way with the first transmission line path 81, is formed of a coil L2 and two capacitors C13 and C14. That is, the coil L2 has one end connected to the AV wire 70 and the other end connected to the receiver circuit 60, the capacitor C13 has one end connected to the AV wire 70 and the other end earthed to the ground, and the capacitor C14 has one end connected to the receiver circuit 60 and the other end earthed to the ground. Each capacitance value of the capacitors C13 and C14 is 7 pF and an inductance value of the coil L2 is 39 nH.

Radio wave receiving characteristics in the surrounding area of the rear bumper 90 in the receiver 33 for the smart entry system 1 are shown in FIG. 4. The graph in FIG. 4 shows a state where the portable device 3 is arranged in the range of −90° to 90° (portable device arrangement angle) at a point in the distance of 50 cm or 100 cm from a reference point SP set in a center of the vicinity of the vehicle behind the vehicle 100 (FIG. 3) and upon reception of a transmission radio wave transmitted from the portable device 3 at the receiver 33, a voltage of a signal inputted to the receiver circuit 60 is distributed for each certain angle in FIG. 3. As shown in FIG. 3, a portable device arrangement angle of 0° is an angle where the portable device 3 is arranged right in opposition to the rear side of the vehicle 100 or the AV electric wire 70 in the rear bumper 90.

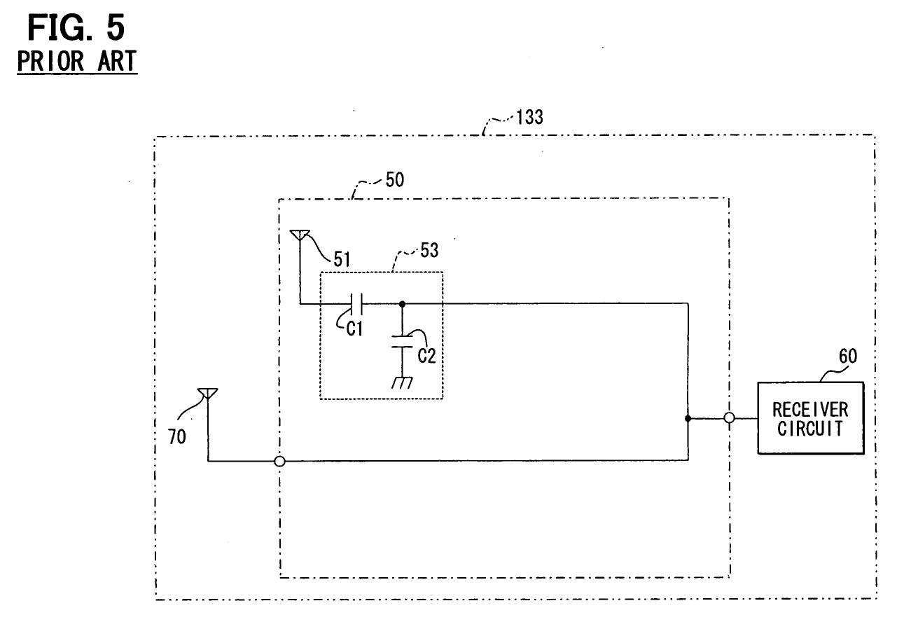

For comparison, receiving characteristics in the surrounding area of the rear bumper 90 of a conventional exemplary receiver 133 shown in FIG. 5 are shown in FIG. 4, together with the receiving characteristics of the receiver 33. As shown in FIG. 5, the receiver 133 is the same as the receiver 33 except for omission of the Wilkinson combining circuit 55.

In addition, a solid line L1 and a broken line L2 in FIG. 4 are respectively angle distributions of the receiver 33 in the distances of 50 cm and 100 cm. A chain line L3 and a chain double-dashed line L4 in FIG. 4 are respectively angle distributions of the receiver 133 in the distances of 50 cm and 100 cm.

As shown in FIG. 4, in regard to each of angle distributions in the distances of 50 cm and 100 cm, input voltages of the receiver circuit 60 in the receiver 33 are larger than that in the receiver 133 over the entire range (from −90 to 90°) of the portable device arrangement angle.

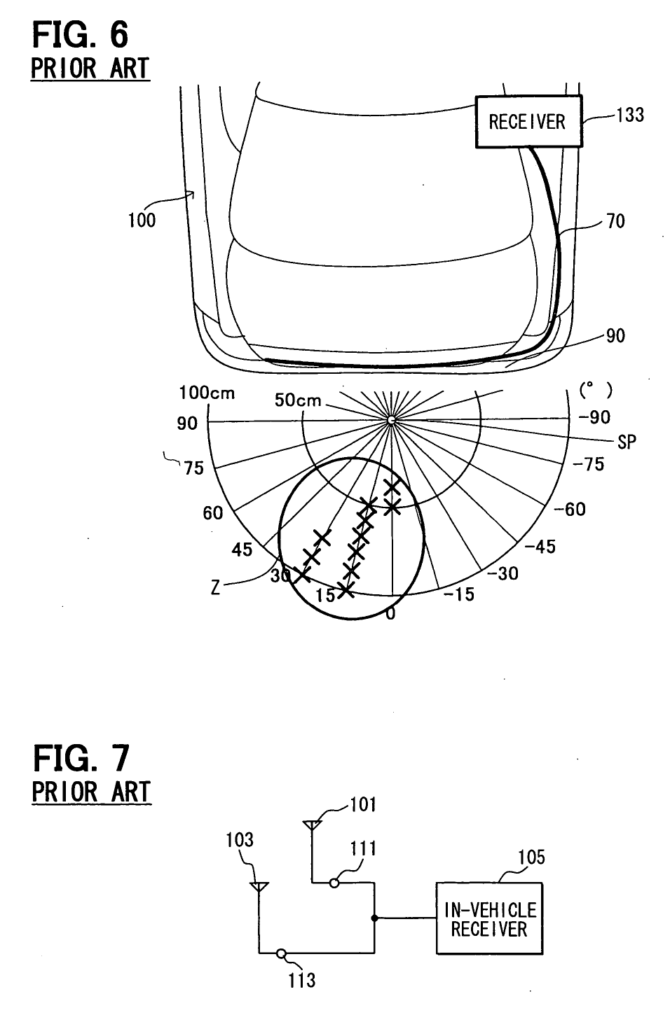

In the receiver 133, as shown in FIG. 6, there exists a region (inoperative area) Z within the surrounding area of the rear bumper 90, where it is difficult to receive a transmission radio wave to be transmitted from the portable device 3 at a sufficient level. On the other hand, in the receiver 33, the input voltage of the receiver circuit increases to the level shown in FIG. 4, thereby eliminating the inoperative area.

In the smart entry system 1 as constructed above, the built-in antenna 51 receives a response signal transmitted from the portable device 3 and also the AV wire 70 receives a response signal transmitted from a region where it is difficult for the built-in antenna 51 to receive the response signal, within the surrounding area of a vehicle where the receiver 33 is mounted. In addition, the Wilkinson combining circuit 55 receives input of the first receiving signal as the response signal received by the built-in antenna 51 and the second receiving signal as the response signal received by the AV wire 70 and outputs the signal produced by combining the input of the first receiving signal and second receiving signal.

That is, since the first receiving signal from the built-in antenna 51 and the second receiving signal from the AV wire 70 are inputted via the Wilkinson combining circuit 55 in the smart entry system 1, the first receiving signal and the second receiving signal do not interfere with each other, thus allowing a combination of the first receiving signal and the second receiving signal.

Accordingly, a region X, which is produced by interference between the first receiving signal and the second receiving signal and it is difficult to receive the response signal, is eliminated.

Impedance characteristics of the AV wire 70 largely vary depending on the state in which the AV wire 70 is mounted. However, since the smart entry system 1 is provided with the Wilkinson combining circuit 55, even if the characteristics of the second receiving signal vary due to the impedance characteristic change of the AV wire 70, this change does not influence the first receiving signal. This allows variations in receiving characteristics of the receiver 33 to be restrained.

In addition, the AV wire 70 is very inexpensive in comparison to an antenna used generally for receiving a radio wave, and therefore, an increase of manufacturing costs for the receiver 33 can be restrained.

The preferred embodiment may be modified in many ways.

For example, the receiver 33 may be used as a receiver other than the smart entry system. The AV wire 70 may be replaced with another antenna used as long as it is capable of receiving a response signal from the portable device 3. The AV wire 70 may be mounted in a member other than the rear bumper 90. That is, since a radio wave dead zone or inoperative area X of the built-in antenna 51 changes with a location position of the receiver 33, a mounting position of the AV wire 70 may be determined to compensate for the radio wave dead zone.

What is claimed is:

1. An in-vehicle receiver for a smart entry system of a vehicle, the receiver comprising:
a first antenna for receiving a portable device wireless signal transmitted from a portable device carried by a user;
a second antenna for receiving the portable device wireless signal from a predetermined region within a neighboring region of the vehicle, the predetermined region being a region where it is difficult for the first antenna to receive the portable device wireless signal; and
a Wilkinson combining circuit for receiving inputs of a first receiving signal as the portable device wireless signal received by the first antenna and a second receiving signal as the portable device wireless signal received by the second antenna and outputting a signal produced by combining the inputs of the first receiving signal and the second receiving signal.

2. The in-vehicle receiver according to claim 1, wherein the second antenna includes a low-voltage AV wire mounted in the vehicle.

3. The in-vehicle receiver according to claim 2, wherein the low-voltage AV wire is located close to the predetermined region.

4. The in-vehicle receiver according to claim 3, wherein the low-voltage AV wire is located in a rear bumper of the vehicle.

5. The in-receiver according to claim 1, wherein the portable device wireless signal is a response signal including an ID code of the portable device so that a vehicle door is automatically locked or unlocked when the portable device is authenticated based on the ID code.

6. An in-vehicle receiver for a vehicle for communication with a portable device, the receiver comprising:
a first antenna provided in an interior of the vehicle for receiving a wireless signal transmitted from the portable device;
a second antenna provided in an exterior of the vehicle for receiving the wireless signal transmitted from the portable device; and
a Wilkinson combining circuit, provided in the interior of the vehicle and connected to the first antenna and the second antenna, for receiving output signals of the first antenna and the second antenna to output a signal by separating from each other and combining the output signals.

7. The in-vehicle receiver according to claim 6, wherein the second antenna is disposed at a location, the wireless signal from which is difficult to be received by the first antenna.

8. The in-vehicle receiver according to claim 7, wherein the Wilkinson combining circuit includes:
a first signal path connected to the first antenna and including a first inductor and first capacitors;
a second signal path connected to the second antenna and including a second inductor and second capacitors, the second signal path is provided in parallel relation to the first signal path; and
a resistor connected to the first antenna and the second antenna at both inputs of the first signal path and the second signal path.

9. The in-vehicle receiver according to claim 8, further comprising:
an impedance matching circuit connected between the first antenna and the input of the first signal path.

10. The in-vehicle receiver according to claim 7, wherein the second antenna is a low-voltage AV wire extending along a bumper of the vehicle.
